(19) United States
(12) Patent Application Publication
(10) Pub. No.: US 2004/0144471 A1
(43) Pub. Date: Jul. 29, 2004

(54) Method for producing a cable

(76) Inventor: Harald Sikora, Bremen (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/470,228

(22) PCT Filed: Jan. 10, 2002
(86) PCT No.: PCT/EP02/00154

(30) Foreign Application Priority Data
Feb. 3, 2001 (DE) 101 04 994.3

(51) Int. Cl. H01B 7/02; H01B 7/17; H01B 13/22; H01B 13/24; H01B 13/14

(52) U.S. Cl. 156/51; 156/244.12; 156/244.21; 156/87; 156/244.27

(57) ABSTRACT

A method for the manufacture of a cable having at least one conductor and at least one sheath surrounding the conductor which is made of an insulating plastic material, wherein the plastic material is applied to the conductor by extrusion and is subsequently cross-linked or cured in a tube-like envelope by supplying heat thereto, wherein a tube-shaped or hose-shaped envelope is continuously produced around the cable sheath in an intimate contact with or at a radial distance therefrom after said extrusion, which envelope is adapted to ensure the counterpressure required for the cross-linking or curing process in the cable sheath.

The invention relates to a method for the manufacture of a cable according to the preamble of claim 1.

Electric cables for power transmission are of a structure which basically is equal in a way to provide at least one centrally guided conductor which is enveloped by at least one sheath or layer of an electrically insulating material. A multi-layered structure of a cable sheath is also known where one or a plurality of layers are made of a semi-conductive material and are used for field-controlling or shielding effects. Layers of this type mostly are distinctly thinner than are the insulating layers proper. It is also known to surround the cable sheath by a braid-like shield of metallic material or by a conductive sheath. Reference will not be made here to the structure as a function of the transmission conditions of the various cables because it is generally known and is not the subject matter of the invention to be described below. Furthermore, an assumption is made below that a cable exhibits its simplest structure, namely a central conductor and a single-layered cable sheath. It is understood that all descriptions also cover all of the other cable structure components.

The insulation layers of electric cables have been manufactured from a plastic material, e.g. PVC, polyethylene (PE) or an appropriate elastomer, for a rather long time. The plastic material is extruded onto the conductor by means of an extruder as is described, for example, in U.S. Pat. No. 3,479,446, U.S. Pat. No. 458,407 or also EP 0 507 988 A1 (there are a large number of documents about this state of the art with those indicated herein only representing a small exemplary enumeration). To impart the necessary mechanical characteristics, specifically mechanical and electrical strength, to the cable sheath, it is required to cross-link or cure the plastic material. Here, the long-chained plastic molecules are connected to each other via cross-links. The cross-linking of such plastic sheaths is done under a pressure and at an elevated temperature. The cross-linking process can be regarded as complete when each volume element of the cable sheath has reached a predetermined temperature of about 190° C. The plastic material to be cross-linked has trapped therein a certain amount of gas which is forced out more or less when the cable sheath heats up. Such an expulsion of the gas causes small bubbles or pores to form in the insulation, and possibly uneven points at the outer circumference of the cable sheath, which impairs the electrophysical characteristics of the cable sheath. Therefore, it is known to produce a counterpressure, which is sufficient to repress a formation of bubbles, around the cable sheath during the cross-linking process. Such a counterpressure is produced, for example, with the aid of a gas atmosphere surrounding the cable sheath. To this end, a long tube is used into which the extruded cable sheath is led while being sealed. Within the tube, the necessary temperature is produced and so is a sufficient pressure which is above the partial gas pressure at the cross-linking temperature in the cable sheath. It is known to introduce steam or saturated steam in such a curing or CV tube. The heated steam simultaneously helps in bringing the cable sheath to the cross-linking temperature. It is also known to use nitrogen in lieu of steam. In such a case, heating is done in another manner, e.g. by heat radiation, inductive heating of the cable, etc. After the cross-linking process, the cable is cooled down under a pressure in a so-called cooling line, which preferably contains water, before it is wound onto an appropriate reel or drum.

If certain speeds are to be achieved in manufacture it is necessary to make the cross-linking line relatively long, particularly for thicker-walled cable sheaths because it naturally takes a certain time until at least the cross-linking temperature has been set across the whole radius of the cable sheath. Thus, so-called CV tubes or curing tubes which are 100 m or more in length are not an uncommon thing. It is understood that manufacturing facilities of this type require a fabrication plant which is appropriately large. It is also known to arrange such plants vertically. They mostly exhibit a gradient when arranged horizontally. This makes necessary appropriate constructional facilities.

It is the object of the invention to provide a method for the manufacture of a cable wherein the cross-linking process can be accomplished more easily and less expensively.

The object is achieved by the features of claim 1.

In the inventive method, a tube-shaped or hose-shaped envelope is continuously produced around the cable sheath after the extrusion of the cable sheath, namely either in an intimate contact with or at a radial distance therefrom. Such an envelope may be produced immediately subsequent to extrusion or at a later time. The essential inventive point is that the CV or curing tube as is used in the state of the art is replaced with an envelope which permanently requires to be re-produced with the cable, and the measures required to cross-link the cable sheath are then taken in such an envelope, i.e. the production of sufficient heat in the cable sheath and a counterpressure sufficient to prevent small gas bubbles from forming from the cable sheath.

If the envelope bears on the outer surface of the cable sheath in an intimate contact and the envelope is of a sufficient radial strength this can produce the necessary counterpressure already so that the thermal expansion of the cable sheath provokes a corresponding counterpressure in the envelope which, in turn, may experience a certain expansion because of its elasticity. It is natural that the envelope may also be applied under a tension with the cable sheath from the very outset so that a counterpressure will be produced at low temperatures already. The partial gas pressure in the cable sheath that rises because of the increase in temperature does not cause a formation of small gas bubbles because a corresponding counterpressure is applied by the envelope. Alternatively, there can be an annular gap between the envelope and cable sheath into which gas or steam is introduced under a pressure similar to the pressurized atmosphere in a CV tube. The pressure of the gaseous medium may also be low because it can heavily increase by heat. Another possibility is to pass a liquid or solid substance into the gap. It is also possible, but not necessary here to pressurize this medium.

If the speech heretobefore and hereinafter is about taking certain constructional and/or physical measures in relation to the envelope and handling of the cable sheath it will be understood that this can also apply merely to a certain portion of length of the envelope.

Various possible ways are imaginable to manufacture an envelope around the cable sheath. According to an aspect of the invention, one is to produce the envelope by extrusion. For this purpose, another extruder may be provided which is arranged after the extruder to apply the cable sheath. Alternatively, a co-extrusion of the cable sheath and envelope may take place.

Another possibility is to produce the envelope at least in part by winding, braiding, taping or the like of an appropriate material. An appropriate material which can be used is a metallic material or a material which is reinforced or armored by a metallic material.

Another aspect provides that the envelope be produced as a corrugated tube. Corrugated tubes are generally known as being in use for various applications. They are advantageous in that they are relatively flexible and exhibit a high radial rigidity at a low material consumption.

The envelope may also be built up from a plurality of layers, the layers being adapted to be separated from each other by an intermediate layer comprising a gas or liquid layer. Within this layer, it is possible to build up an appropriate pressure or to produce it by the thermal expansion of the cable sheath and/or medium from the very beginning.

The heating of said cable sheath can be performed in different manners as are the state of the art, e.g. by radiation heat, contact heat, inductive heating, steam or also a combination of the various heating techniques. Here, using the inventive envelope has the advantage that it is possible to transfer heat to the cable sheath in an efficient way so that the losses of heat are significantly smaller than those in conventional methods.

Alternatively, heating can be performed wholly or partly by a current flow in the conductor, namely directly during production or at a later time, e.g. not before its use following the laying of the cable.

The inventive envelope may remain on the cable later or may be removed. In the latter case, the material of the envelope is preferably re-usable, i.e. either for the manufacture of an envelope or for different purposes. If the envelope remains on the cable it may perform various functions individually or in combination when in use. For example, one is to protect the cable against mechanical stresses or against a penetration of liquid or gas. Another possible option is to make the envelope electrically conductive. It may then serve as a shield or even a return conductor.

If the envelope remains on the cable it is beneficial for the envelope to be designed so as to allow the cable sheath to be relieved from gas. As is known the escape of gas from the cable sheath takes place for a very long period of time even after the cable sheath has chilled. Therefore, an aspect of the invention provides that the envelope be structured or have a multiplicity of fine radial passages such as to enable the cable sheath material to be relieved from gas later. Alternatively, the conductor may be designed such that the removal of gases is effected therethrough. Finally, gas may also be removed by flushing the gap between the cable sheath and envelope with a different gas.

The inventive method allows for a less expensive manufacture of an electric cable. In particular, the spatial and constructional preconditions are far more favourable than those of conventional methods. Thus, it is also possible to produce cables directly at the site of laying, also in a mobile way on vehicles and ships. The invention admits of a continuous manufacture of the cable in a desired length. Cable connectors as are conventionally needed between limited cable lengths installed become unnecessary. Cable connectors increase the expenditure in laying and are susceptible to defects.

The invention will be described in more detail below with reference to two embodiments shown in the drawings.

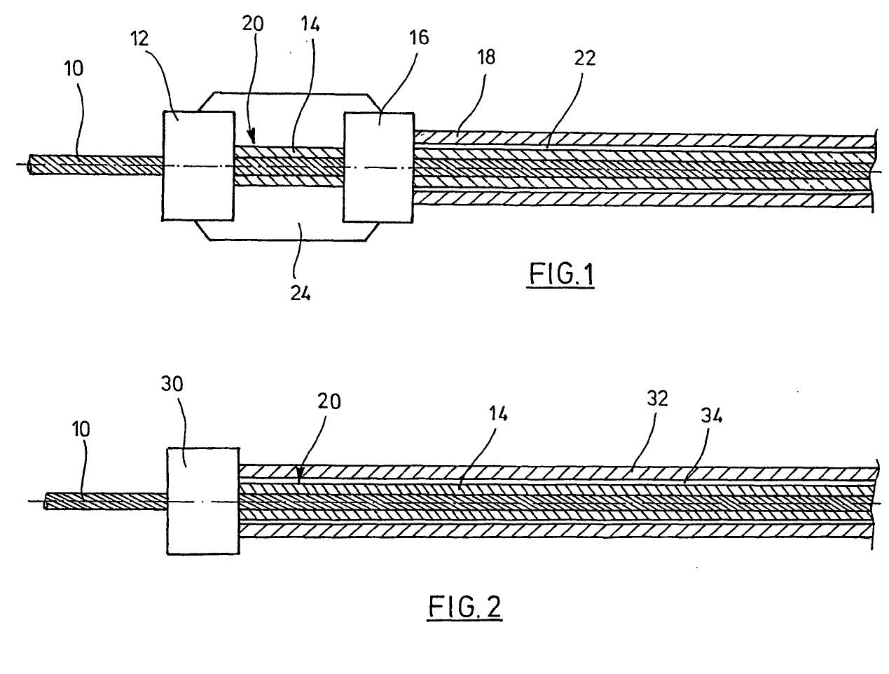

FIG. 1 extremely schematically shows the manufacture of a cable sheath with an envelope according to the invention.

FIG. 2 shows another embodiment of manufacture of a cable with an envelope according to the invention.

Referring to FIG. 1, it can be seen how a conductor 10 of a cable, which may consist of a single wire or a multiplicity of stranded wires and the like, is provided with a cable sheath 14 in an extruder 12 in a known manner. For example, the material is a cross-linkable plastic, e.g. VPE, or a curable rubber mixture, e.g. EPR. An envelope 18 is produced around the cable 20 in another extruder 16. The material of the envelope 18 may be very different as compared to that of the cable sheath 14. It only has to meet the preconditions which are required for the cross-linking of the material of cable sheath 14 which takes place within the envelope 18. It is possible to extrude the envelope 18 directly onto the advancing cable sheath 14 so that there is an intimate contact between the two components. An annularly cylindrical gap 22 is provided in the case of the drawing. Gas under a pressure, e.g. nitrogen or water vapor, or even a non-pressurized or pressurized liquid may be led into the gap 22. The gas or liquid or another technique, which is not shown, are used to heat the cable sheath 14 in order that it be brought to a cross-linking or curing temperature of 190° C., for example, in each volume fraction after a certain time. Normally, such temperature is necessary to cross-link the cable material. The pressure in the gap 22 now provides that gases which cause a formation of bubbles in the cable sheath 14 are not generated while the cable sheath 14 heats up.

The envelope 18 may be removed again, starting from a certain cable length behind the extruder 16, after the cross-linking and cool-down procedures and the material may be used anew for the manufacture of a fresh envelope or other purposes. It is also possible to leave the envelope on the cable, for which case it is most convenient that the envelope directly bears on the cable sheath. In this case, the envelope may serve as a mechanical or anti-moisture protection, may be resorted to as a shield by making it conductive, or may serve as a return conductor.

In the embodiment of FIG. 1, a pressure vessel 24 is provided which tightly closes the gap between extruders 12, 16 and in which a higher pressure is produced. The pressure approximately corresponds to the counterpressure required for the partial gas pressure in the cable sheath 14.

Since the cable 20 produced in FIG. 2 is of the same structure as is the cable 20 of FIG. 1 like reference numbers are used for both the conductor 10 and cable sheath 14. In FIG. 2, a single extruder 30 is provided through which both the cable sheath 14 and an envelope 32 are extruded which is comparable to the envelope 18. Again, a gap 34 which equals the gap 22 is located between the cable sheath 14 and envelope 32. The procedural measures and possibilities described for the embodiment of FIG. 1 equally apply to the embodiment of FIG. 2 so that they will not be explained once more in detail.

1. A method for the manufacture of a cable having at least one conductor and at least one sheath surrounding the conductor which is made of an insulating plastic material, wherein the plastic material is applied to the conductor by extrusion and is subsequently cross-linked or cured in a tube-like envelope by supplying heat thereto, characterized in that a tube-shaped or hose-shaped envelope (18, 32) is continuously produced around the cable sheath (14) in an intimate contact with or at a radial distance therefrom after said extrusion, which envelope is adapted to ensure the counterpressure required for the cross-linking or curing process in the cable sheath (14).

2. The method as claimed in claim 1, characterized in that the sheath (14) is made of plastic, metal or a combination thereof or may also be manufactured from a plurality of layers.

3. The method as claimed in one or either of claims 1 to 2, characterized in that the envelope (18, 32) is wholly or partly produced by extrusion.

4. The method as claimed in one or more of claims 1 to 3, characterized in that a gaseous medium or steam is introduced under a pressure in between the envelope (18, 32) and cable sheath (14).

5. The method as claimed in one or more of claims 1 to 3, characterized in that a gaseous medium, liquid medium, solid medium or a combination thereof is introduced in between the envelope and cable sheath.

6. The method as claimed in one or more of claims 1 to 3, characterized in that a gaseous medium, liquid medium, solid medium or a combination thereof is introduced in between the envelope and cable sheath that is apt to build up or maintain the pressure required in cross-linking or curing the core.

7. The method as claimed in one or more of claims 1 to 6, characterized in that the material or some part of the material of said envelope is structured or has a multiplicity of fine passages such as to permit the cable sheath to be relieved from gas later.

8. The method as claimed in one or more of claims 1 to 7, characterized in that the conductor (10) is of a design such that the cable sheath may wholly or partly be relieved from gas later via said conductor.

9. The method as claimed in one or more of claims 1 to 8, characterized in that said envelope or some part of said envelope is electrically conductive or semi-conductive to form a return conductor or shield.

10. The method as claimed in one or more of claims 1 to 9, characterized in that said envelope or some part of said envelope is configured as a mechanical protection or a protection preventing the penetration of water or moisture.

11. The method as claimed in one or more of claims 1 to 10, characterized in that said envelope is configured to be wholly or partly removable.

12. The method as claimed in claim 11, characterized in that the material of said envelope is re-usable or further usable.

13. The method as claimed in one or more of claims 12, characterized in that said envelope is applied directly subsequent to extrusion or in a later operation.

14. The method as claimed in one or more of claims 1 to 13, characterized in that said envelope is built up from a plurality of layers.

15. The method as claimed in one or more of claims 1 to 14, characterized in that a gas, liquid medium or solid medium is introduced under a pressure in between adjacent layers of the envelope.

16. The method as claimed in one or more of claims 1 to 15, wherein a gas, liquid medium or solid medium is introduced in between adjacent layers of the envelope that is apt to build up or maintain the required counterpressure during cross-linking or curing.

17. The method as claimed in one or more of claims 1 to 16, characterized in that said envelope is produced at least in part by winding, braiding, taping or the like of an appropriate material.

18. The method as claimed in one or more of claims 1 to 17, characterized in that said envelope (32) is co-extruded with the cable sheath (14).

19. The method as claimed in one or more of claims 1 to 18, characterized in that said envelope is armored, preferably by a metallic material.

20. The method as claimed in one or more of claims 1 to 19, characterized in that said envelope is produced wholly or partly as a corrugated tube.

21. The method as claimed in one or more of claims 1 to 20, characterized in that the heating of said cable sheath is performed by radiation, contact heat, inductive heating, high-frequency irradiation, steam or a combination thereof, for the purpose of cross-linking or curing.

22. The method as claimed in one or more of claims 1 to 20, characterized in that said heating is performed wholly or partly by a flow of current in the conductor, for the purpose of cross-linking or curing said cable sheath.

23. The method as claimed in claim 22, characterized in that said heating is performed wholly or partly by loading the cable by a current at a later time or when in operation, for the purpose of cross-linking or curing said cable sheath.

24. The method as claimed in one or more of claims 1 to 23, characterized in that said cable is manufactured on mobile units such as vehicles or ships.

25. The method as claimed in one or more of claims 1 to 24, characterized in that said cable is manufactured on mobile units directly at the site of cable installation.
